(19) United States
(12) Patent Application Publication
(10) Pub. No.: US 2025/0148573 A1
(43) Pub. Date: May 8, 2025

(54) IMAGE PROCESSING METHOD, IMAGE PROCESSING APPARATUS, IMAGE PROCESSING SYSTEM, IMAGE PICKUP APPARATUS, LEARNING METHOD, LEARNING APPARATUS, AND MEMORY

(71) Applicant: CANON KABUSHIKI KAISHA, Tokyo (JP)

(72) Inventor: YOSHINORI KIMURA, Tochigi (JP)

(21) Appl. No.: 18/940,615

(22) Filed: Nov. 7, 2024

(30) Foreign Application Priority Data
Nov. 8, 2023 (JP) 2023-190848
Oct. 8, 2024 (JP) 2024-176390

(51) Int. Cl. G06T 5/60; G06T 3/4046; G06T 5/20

(52) U.S. Cl. CPC G06T 5/60; G06T 3/4046; G06T 5/20; G06T 2207/20081; G06T 2207/20084

(57) ABSTRACT

An image processing method includes generating a first image by inputting an input image or an image based on the input image into a first machine learning model, generating a second image by inputting the first image into a second machine learning model different from the first machine learning model, and generating a third image using the first image and the second image. Each of the first image, the second image, and the third image has a larger number of pixels than those of the input image. The second image has fewer high-frequency components than those of the first image.

### BACKGROUND

### Technical Field

The present disclosure relates to an image processing method, an image processing apparatus, an image processing system, an image pickup apparatus, a learning method, a learning apparatus, and a memory.

### Description of Related Art

Japanese Patent Laid-Open No. 2022-046219 discloses a method for generating two upscaled images with different effects using a deep learning (DL) model. More specifically, Japanese Patent Laid-Open No. 2022-046219 generates a feature map from an input low-resolution image using the DL model, and first and second high-resolution intermediate images (upscaled images) from the feature map. The feature map is intermediate data obtained by image processing using the DL model, and is a plurality of images concatenated in the channel (depth) direction. In the DL, a feature map generally has channels more than that of an image. For example, a color image has three RGB channels, while a feature map has 64 or 128 channels. The method disclosed in Japanese Patent Laid-Open No. 2022-046219 can generate two upscaled images with different effects using the DL model.

The method disclosed in Japanese Patent Laid-Open No. 2022-046219 generates images from the feature map with a large number of channels (large size), and thus increases the number of filter convolutions and a computational load. In other words, two upscaled images with different effects using the DL model cannot be generated with a small computational load.

### SUMMARY

An image processing method according to one aspect of the disclosure includes generating a first image by inputting an input image or an image based on the input image into a first machine learning model, generating a second image by inputting the first image into a second machine learning model different from the first machine learning model, and generating a third image using the first image and the second image. Each of the first image, the second image, and the third image has a larger number of pixels than those of the input image. The second image has fewer high-frequency components than those of the first image. An image processing apparatus corresponding the above image processing method also constitutes another aspect of the disclosure. An image pickup apparatus and an image processing system having the above image processing apparatus also constitutes another aspect of the disclosure. A storage medium storing a program that causes a computer to execute the above image processing method also constitutes another aspect of the disclosure.

A training method according to another aspect of the disclosure includes acquiring a first training image having a low resolution or an image based on the first training image, and a second training image having a high resolution corresponding to the first training image, and training a first machine learning model and a second machine learning model based on the first training image or the image based on the first training image and the second training image. A calculating method of a loss during training of the first machine learning model and a calculating method of a loss during training of the second machine learning model are different from each other. A storage medium storing a program that causes a computer to execute the above training method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates a training flow of a machine learning model according to a first embodiment.

FIG. 2 is a block diagram of an image processing system according to the first embodiment.

FIG. 3 is an external view of the image processing system according to the first embodiment.

FIG. 4 is a flowchart regarding learning of the machine learning model according to the first embodiment.

FIG. 5 is a flowchart regarding the generation of an output image using the machine learning model according to the first embodiment.

FIG. 6 is a block diagram of an image processing system according to a second embodiment.

FIG. 7 is an external view of the image processing system according to the second embodiment.

FIG. 8 is a block diagram of an image processing system according to a third embodiment.

FIG. 9 is a flowchart regarding generation of an output image using the machine learning model according to the third embodiment.

FIG. 10 explains an overview of each embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

Before specific examples are described, an overview of each embodiment will be described. Each example uses a DL model (machine learning model) to generate two upscaled images with different effects. In each embodiment, image processing using the DL model employs a convolutional neural network that repeatedly convolves a filter with an input image, adds a bias, and performs nonlinear conversion to obtain an output image with a desired effect. The DL model includes a weight including the filter and bias of the convolutional neural network and a network configuration. In each embodiment, the calculation load of image processing using the DL model is mainly determined by the filter size (e.g., length, width, the number of channels, the number of filters) that is used for convolution, the size of a counterpart to be convolved with the filter (e.g., length, width, and the number of channels of an image or feature map), and the number of convolution layers. The feature map will be described later.

In each embodiment, upscaling is image enlargement processing configured to generate a sharp high-resolution image with a large number of pixels by estimating high-frequency components that cannot be expressed in a low-resolution image with a small number of pixels. In each embodiment, an upscaled image with a high effect is a high-resolution image that contains many high-frequency (high-resolution) components, and an upscaled image with a low effect is a high-resolution image that contains fewer high-frequency (low-resolution) components.

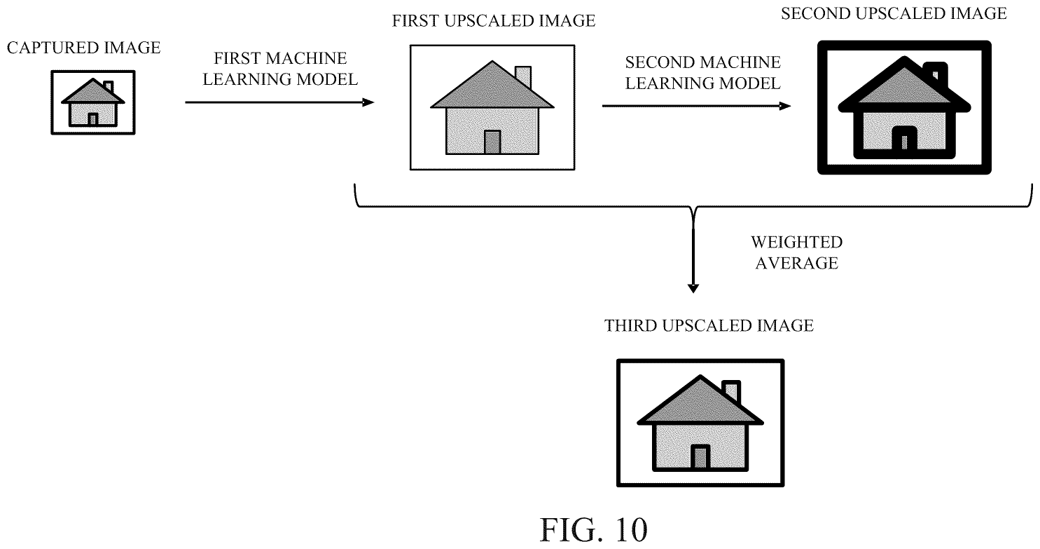

Referring now to FIG. 10, a description will be given of an overview of each embodiment. FIG. 10 explains the overview of each embodiment. In each embodiment, a high-resolution upscaled image (first image) is generated by first inputting a low-resolution image (input image) into a DL model (first machine learning model).

Next, a high-resolution upscaled image (second image) with a lower effect is generated by inputting the first image into a DL model (second machine learning model different from the first machine learning model). In this embodiment, each of the number of pixels of the first image and the number of pixels of the second image is larger than the number of pixels of the input image. The number of pixels of the first image and the number of pixels of the second image may be equal to each other. The first image and the second image contain high-frequency (high-resolution) components more than those of an interpolated image of a captured image. The first image contains high-frequency components more than those of the second image. The interpolated image is a bicubic interpolated image or a bilinear interpolated image, but is not limited to them.

Finally, a high-resolution upscaled image (third image) is generated by calculating a weighted average of the first image and the second image. In this embodiment, the number of pixels of the third image is larger than the number of pixels of the captured image (input image). The number of pixels in the third image may be equal to each of the number of pixels in the first image and the number of pixels in the second image. The third image contains high-frequency (higher-resolution) components more than those of the interpolated image of the captured image, and contains high-frequency components between those of the first image and the second image.

In each embodiment, a first image with a high effect is input to the DL model to generate a second image with a lower effect. Thereby, an estimated image is generated from an image with a small number of channels, and thus the number of filter convolutions and the calculation load can be reduced. In the DL, the calculation load in generating an image with a low effect from an image with a high effect (in reducing high-frequency components to generate a blurred image) is generally less than the calculation load in generating an image with a high effect from an image with a low effect (in increasing high-frequency components to increase the resolution). Therefore, each embodiment can generate two upscaled images with different effects using the DL model with a small computational load.

In each embodiment, the third image may be generated by calculating a weighted average of the first image and the second image with different effects. Thereby, the effect of the third image can be fine-adjusted by adjusting the weight for the weighted average.

The effect of the resulting upscaled image can be adjusted by calculating a weighted average of the first image with a high effect and a bicubic interpolated image of the captured image and by adjusting the weight for the weighted average. However, the bicubic interpolated image of the captured image does not contain high-frequency components, and thus the weighted average reduces the high-frequency components contained in the first image, which is the effect of upscaling. Therefore, each embodiment may calculate a weighted average with a second image that contains frequency components higher than those of the interpolated image.

A second image with a lower effect can be generated by blurring the first image with a high effect without using a DL model. However, for the above reasons, this method reduces the high-frequency components contained in the first image, which is the effect of upscaling, and thus a second image may be generated with frequency components higher than those of the interpolated image using a machine learning model, as in each embodiment.

The image processing method described above is merely illustrative, and each embodiment is not limited to this example. A detailed description will now be given below of the image processing method according to each embodiment.

### First Embodiment

A description will now be given of an image processing system 100 according to the first embodiment of the present disclosure. In this embodiment, image processing is learned and executed to generate two upscaled images with different effects using a DL model with a small calculation load.

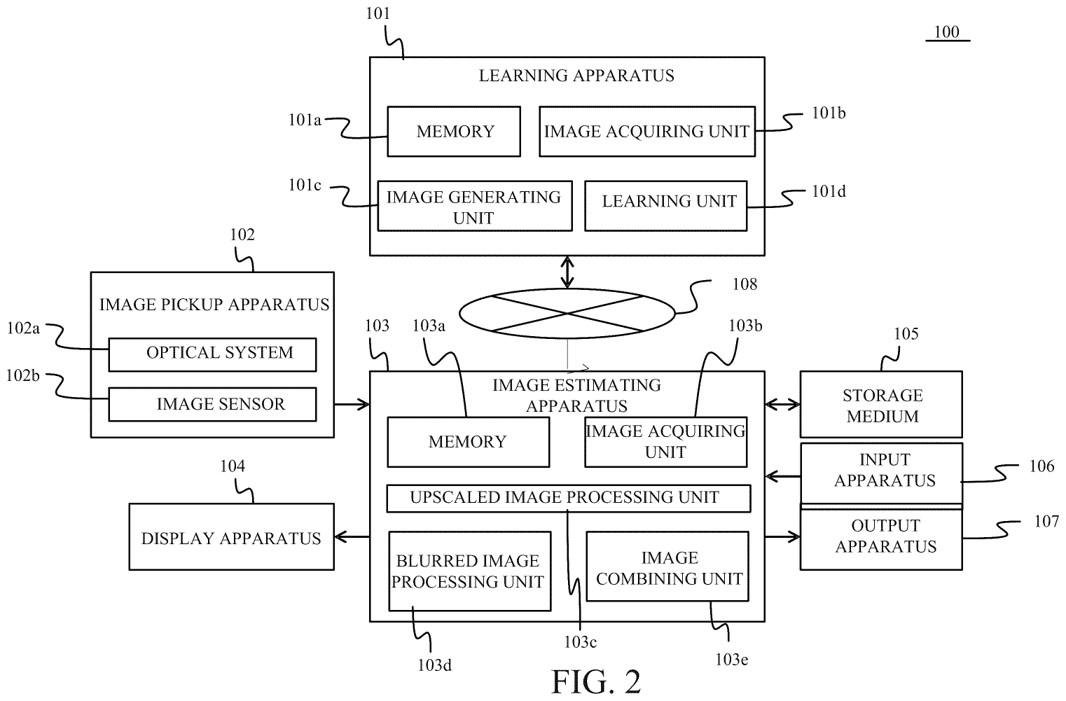

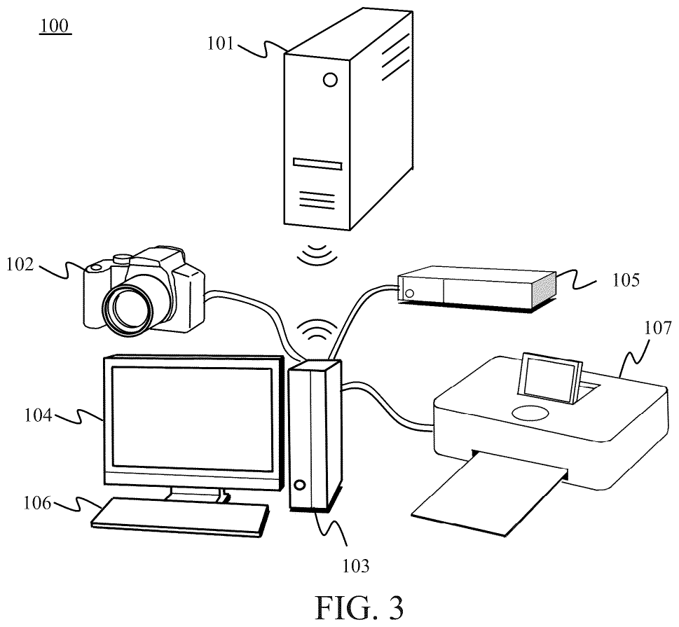

FIG. 2 is a block diagram of the image processing system 100. FIG. 3 is an external view of the image processing system 100. The image processing system 100 includes a learning apparatus 101, an image pickup apparatus 102, an image estimating apparatus (image processing apparatus) 103, a display apparatus 104, a storage medium 105, an input apparatus 106, an output apparatus 107, and a network 108.

The learning apparatus 101 includes a memory 101a, an image acquiring unit 101b, an image generator 101c, and a learning unit 101d.

The image pickup apparatus 102 includes an optical system 102a and an image sensor 102b. The optical system 102a condenses light incident on the image pickup apparatus 102 from object space. The image sensor 102b receives an optical image of an object formed through the optical system 102a to acquire a captured image (low-resolution image). The image sensor 102b is a Charge Coupled Device (CCD) sensor or a Complementary Metal-Oxide Semiconductor (CMOS) sensor. Information on an imaging condition of the captured image (e.g., a pixel pitch of the image sensor 102b, a type of optical low-pass filter, ISO speed (or sensitivity), etc.) can be obtained together with the image. A development condition of the captured image (e.g., noise reduction intensity, sharpness strength, image compression rate, etc.) can also be obtained together with the image. The image information obtained together with the image can be transmitted to an image acquiring unit 103b in the image estimating unit 103 described later, together with the image. FIG. 2 omits a memory for storing the acquired image, a display unit for displaying the image, a transmitter for transmitting the image to the outside, an output unit for storing the image in an external memory, and a control unit for controlling each component in the image pickup apparatus 102.

The image estimating unit 103 includes a memory 103a, an image acquiring unit 103b, an upscaled image processing unit (first generator) 103c, a blurred image processing unit (second generator) 103d, and an image combining unit (third generator) 103e. The image estimating unit 103 performs (image) processing for a low-resolution image (i.e., captured image, input image). More specifically, first, the image acquiring unit 103b acquires a low-resolution image. Next, the upscaled image processing unit 103c or the blurred image processing unit 103d generates two high-resolution images with different upscaled effects. Thereafter, the image combining unit 103e combines the two high-resolution images to generate a high-resolution image.

The low-resolution image may be an image captured by the image pickup apparatus 102 or may be an image stored in the storage medium 105. The upscaled image processing unit 103c, the blurred image processing unit 103d, and the image combining unit 103e may be executable using an integrated DL model. Alternatively, the upscaled image processing unit 103c and the blurred image processing unit 103d may be executable using an integrated DL model. Alternatively, the upscaled image processing unit 103c and the blurred image processing unit 103d may be executable using separate DL models.

The DL model is mainly used for image processing, and the weight information is read out of the memory 103a. The weight is obtained by learning in the learning apparatus 101, and the image estimating unit 103 previously reads the weight information from the memory 101a via the network 108 and stores it in the memory 103a. The stored weight information may be a numerical value of the weight, or may be in an encoded format.

The upscaled image is output to at least one of the display apparatus 104, the storage medium 105, and the output apparatus 107. The display apparatus 104 is, for example, a liquid crystal display or a projector. A user can confirm the image being processed via the display apparatus 104 and perform image editing work via the input apparatus 106. The storage medium 105 is, for example, a semiconductor memory, a hard disk drive, a server on a network, etc. The input apparatus 106 is, for example, a keyboard or a mouse, etc. The output apparatus 107 is, for example, a printer, etc.

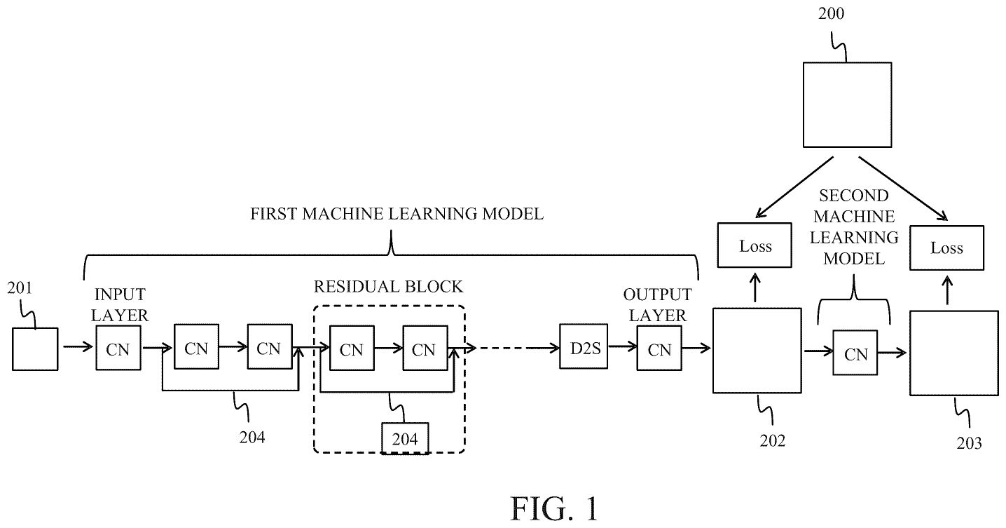

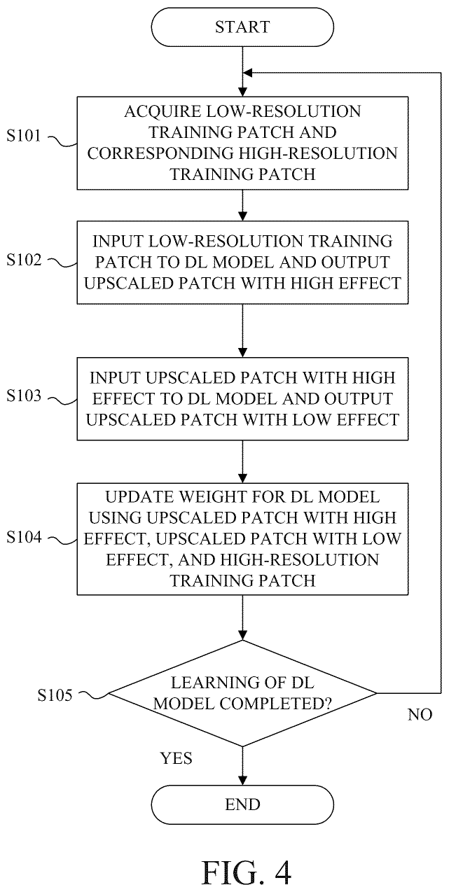

Referring now to FIGS. 1 and 4, a description will be given of a learning method of a DL model (a method for manufacturing a learned model) to be executed by the learning apparatus 101 according to this embodiment. FIG. 1 illustrates the learning flow of the DL model. FIG. 4 is a flowchart regarding learning of the DL model. Each step in FIG. 4 is mainly executed by the image acquiring unit 101b or the learning unit 101d.

First, in step S101, the image acquiring unit 101b acquires a low-resolution training patch (first training image) 201 and a high-resolution training patch (second training image, ground truth image) 200 corresponding to the low-resolution training patch. The high-resolution training patch 200 and the low-resolution training patch 201 correspond to the symbols in FIG. 1. In this embodiment, a patch is an image having a predetermined number of pixels. For example, a low-resolution training patch has 128×128×3 pixels, and a corresponding high-resolution training patch has 256×256×3 pixels. In this case, since the vertical and horizontal sizes are doubled, the upscaling factor is 2 (i.e., enlarged by 4 times in terms of the number of pixels). The upscaling factor is not limited to 2, and may be any factor as long as the low-resolution training patch and the corresponding high-resolution training patch can be acquired.

In this embodiment, each of the low-resolution training patch and the high-resolution training patch is a three-channel color image having RGB information, but this embodiment is not limited to this example. For example, it may be a single-channel monochrome image having luminance information extracted from a color image by the image generator 101c, or an image obtained by decomposing a single-channel monochrome image into a plurality of small patches by the image generator 101c and by concatenating the small patches in the depth (channel) direction.

In this embodiment, the high-resolution training patch corresponding to the low-resolution training patch is an image of the same object captured in the same scene with a different resolution (e.g., number of pixels). Such a set of images may be obtained by capturing the same object in the same scene using optical systems with different focal lengths, and cutting out corresponding portions of the two obtained images. Alternatively, an equivalent low-resolution training patch acquired by the image pickup apparatus 102 and a corresponding high-resolution training patch that is less affected by blurring (aberrations or diffractions) caused by the optical system 102a may be generated by numerical calculation. This embodiment generates the high-resolution training patch corresponding to the low-resolution training patch by numerical calculation, but is not limited to this example. As described later, the high-resolution training patch is an image corresponding to a ground truth image, which is a target of an upscaled patch output from the DL model by inputting a low-resolution training patch. Therefore, the high-resolution training patch contains high-frequency components more than those of the low-resolution training patch (or has higher resolution).

Next, in step S102, the learning unit 101d inputs the low-resolution training patch (first training image) 201 to the DL model (first machine learning model) and outputs (generates) an upscaled patch 202 with a high upscaled effect. Information on the imaging condition and development condition may be input to the DL model together with the low-resolution training patch. For example, images each having the ISO speed as a pixel value may be concatenated in the depth (channel) direction of the low-resolution training patch and input to the DL model. Thereby, upscaling can be achieved according to the imaging condition and development condition of the low-resolution training patch. The low-resolution training patch may also be enlarged by interpolation to the same number of pixels as that of the high-resolution training patch and then input to the DL model. In this case, the DL model is learned in the steps described later so as to estimate high-frequency components from a patch obtained by interpolating the low-resolution training patches.

Next, in step S103, the learning unit 101d inputs the upscaled patch (first upscaled patch) 202 with a high effect generated in step S102 to the DL model (second machine learning model). The learning unit 101d then outputs (generates) an upscaled patch (second upscaled patch) 203 having an effect lower than that of the upscaled patch 202. Both the upscaled patches 202 and 203 are estimates of the high-resolution training patch (second training image, ground truth image) 200. How the two upscaled images are differentiated in effect through learning will be described later.

Next, in step S104, the learning unit 101d updates the weight for the DL model (first machine learning model, second machine learning model). That is, the learning unit 101d updates the weight for the DL model by using an error (loss function) based on the high-resolution training patch 200 and the upscaled patch 202 or 203.

This embodiment calculates an error (loss) between the high-resolution training patch 200 and the upscaled patch 202 using the adversarial loss, i.e., a generative adversarial network (GAN). The generative adversarial network is a method in which the upscaled patch 202 is input, a separately prepared image recognition DL model (identifier) is made to distinguish whether it is a real high-resolution image or a fake created by the DL model, and a large penalty (error) is applied if it is detected as a fake. By performing learning so as to reduce the error based on the generative adversarial network, the finally obtained upscaled patch 202 becomes an image that contains many high-frequency components (high effect) and is difficult to distinguish from the high-resolution training patch 200.

This embodiment calculates the error (loss) between the high-resolution training patch 200 and an upscaled patch 203 using the mean squared error (MSE). The MSE is a mean squared value of a difference between values of corresponding pixels in the high-resolution training patch 200 and the upscaled patch 203. In general, even if learning is performed to reduce the error based on the MSE, the finally obtained upscaled patch 203 will be a more blurred image (with a lower effect) than the high-resolution training patch 200.

This embodiment uses the generative adversarial network and the MSE as a method for calculating the error, but is not limited to this example. Other methods may be used as long as two upscaled patches 202 and 203 with different effects are obtained.

This embodiment updates the weight for the DL model (first machine learning model, second machine learning model) using a backpropagation method so that the weighted average of the errors calculated by the generative adversarial network and the MSE is reduced. However, this embodiment is not limited to this example. After the weight for the DL model (first machine learning model) is learned based on the error calculated by the generative adversarial network, the learned weight may be fixed, and then the weight for the DL model (second machine learning model) may be sequentially learned based on the error calculated by the MSE. That is, in this embodiment, the first and second machine learning models may be simultaneously (integrally) learned, or the first and second machine learning models may be separately learned.

Next, in step S105, the learning unit 101d determines whether or not the learning of the DL model is completed. Completion can be determined by determining whether the number of repetitions of learning (i.e., updating the weights) reaches a predetermined value, or whether a change amount in the weight during updating is smaller than a predetermined value, or the like. In a case where learning is determined to be not completed, the flow returns to step S101, and a plurality of new low-resolution training patches (first training images) 201 and corresponding high-resolution training patches (ground truth images) 200 are obtained. On the other hand, in a case where learning is determined to be completed, the weight information is stored in the memory 101a.

This embodiment uses the configuration of the convolutional neural network illustrated in FIG. 1 as the DL model, but is not limited to this example.

CN in FIG. 1 represents a convolutional layer. The CN convolutes the input with the filter, and add the result to a bias, and nonlinearly transforms the result using an activation function. Each component of the filter and the bias may have arbitrary initial values, and are determined by random numbers in this embodiment. The activation function can use, for example, Rectified Linear Unit (ReLU), a sigmoid function, a hyperbolic tangent function (Tanh), or the like. A multidimensional array output at each layer except the output layer of the DL model is a feature map. In general, the feature map has a four-dimensional array with dimensions of batch, length, width, and channel. A skip connection 204 combines feature maps output from discontinuous layers. The feature maps may be combined by taking the sum of each element, or by concatenating them in the channel direction. This embodiment uses the sum of respective elements.

The elements (blocks or modules) in the dotted frame in FIG. 1 represent residual blocks. A network in which residual blocks are multilayered is called a residual network and is widely used for image processing using DL. However, this embodiment is not limited to this example. In this embodiment, other elements such as an inception module or a dense block with dense skip connections may be layered to form a network. The inception module is a module that juxtaposes convolution layers with different convolution filter sizes and integrates a plurality of obtained feature maps to form a final feature map.

The computation load (e.g., convolution calculation) may be reduced by reducing the feature map in the layer close to the input, by expanding the feature map in the layer close to the output, and by reducing the size of the feature map in the intermediate layer. Pooling, stride, etc. can be used to reduce the feature map. Deconvolution (or transposed convolution), depth to space, interpolation, etc. can be used to enlarge the feature map.

The low-resolution feature map is enlarged to become a high-resolution feature map and input to the output layer. This embodiment uses, as a method of upsampling a feature map, depth-to-space (D2S in FIG. 1), which rearranges information in the channel direction of the feature map in a spatial (vertical and horizontal) direction, but is not limited to this example. In a case where a low-resolution patch is enlarged to the same number of pixels as that of a high-resolution patch using interpolation in step S102 and then enlarged to the DL model, the enlargement operation of the feature map before the output layer is not necessarily required.

In this embodiment, the high-resolution feature map upsampled by depth-to-space is processed in the convolution layer (output layer (single convolution layer) in FIG. 1) to generate an upscaled patch 202. In Japanese Patent Laid-Open No. 2022-046219, this high-resolution feature map is processed in a separately prepared convolution layer (unillustrated output layer) to generate the upscaled patch 203. Therefore, in Japanese Patent Laid-Open No. 2022-046219, the upscaled patch 203 is generated from a feature map with a large number of channels (large size), and thus the number of times the filter convolutions and a calculation load increase. On the other hand, in this embodiment, the upscaled patch 202 is processed in a convolution layer (second machine learning model) to generate the upscaled patch 203. Hence, this embodiment generates the upscaled image from an image with a small number of channels (small size) and thus can reduce the number of filter convolutions and the calculation load.

The scale (model scale) of the second machine learning model in this embodiment is smaller than the model scale of the corresponding machine learning model in Japanese Patent Laid-Open No. 2022-046219. The corresponding machine learning model is a separately prepared convolution layer (unillustrated output layer) that processes the above high-resolution feature map, and is the same model scale as the output layer of FIG. 1 in this embodiment. That is, the scale (model scale) of the second machine learning model is smaller than the scale (model scale) of the output layer in the first machine learning model. In this embodiment, the overall scale of the first machine learning model is larger than the model scale of its output layer. Thus, the model scale of the second machine learning model is smaller than the model scale of the output layer in the first machine learning model. The model scale of the second machine learning model may be smaller than half of the model scale of the output layer in the first machine learning model. The model scale of the second machine learning model may be smaller than one-fifth of the model scale of the output layer in the first machine learning model. The model scale of the second machine learning model may be smaller than one-tenth of the model scale of the output layer in the first machine learning model.

In this embodiment, the model scale of the machine learning model (the scale of each of the output layer of the first machine learning model and the second machine learning model) is expressed by the following equation (1):

$${\sum }_{l = 1}^{L} {k}_{l} \times {k}_{l} \times {c}_{l} \times {n}_{l} \qquad ( 1 )$$

Here, L is the number of convolution layers, k₁ is the kernel size of the convolution filter in the 1-th layer (1=1 to L), c₁ is the number of channels of the convolution filter in the 1-th layer, and n₁ is the number of convolution filters in the 1-th layer. The number of layers L of the output layer in the first machine learning model is 1 (L=1). Equation (1) assumes a square convolution filter with no stride or dilation, which is a normal two-dimensional convolution that does not separate in the depth direction.

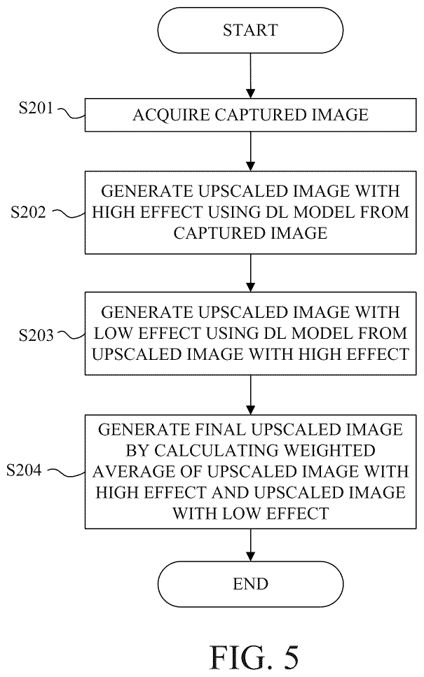

Referring now to FIG. 5, a description will be given of the estimation (DL upscaling) performed by the image estimating unit 103 according to this embodiment. FIG. 5 is a flowchart illustrating processing of generating an upscaled image (output image, third image) from a low-resolution image (input image) using a DL model (first machine learning model, second machine learning model).

Steps in FIG. 5 are mainly executed by the image acquiring unit 103b, the upscaled image processing unit 103c, the blurred image processing unit 103d, or the image combining unit 103e in the image estimating unit 103. As described above, the upscaled image processing unit 103c, the blurred image processing unit 103d, and the image combining unit 103e may be configured as an integrated DL model. Alternatively, the upscaled image processing unit 103c and the blurred image processing unit 103d may be configured as an integrated DL model, and the image combining unit 103e may be configured as a separate image processing unit. Alternatively, the upscaled image processing unit 103c and the blurred image processing unit 103d may be configured as separate DL models, and the image combining unit 103e may also be configured as a separate image processing unit.

First, in step S201, the image acquiring unit 103b acquires a captured image (input image). The captured image is a low-resolution image, as in learning. In this embodiment transmits the captured image from the image pickup apparatus 102, but is not limited to this example. For example, a captured image stored in the memory 103a may be used.

Next, in step S202, the upscaled image processing unit 103c generates an upscaled image (first image) with a high effect by inputting the captured image to a DL model (first machine learning model). To generate an upscaled image with a high effect, a convolutional neural network similar to the configuration illustrated in FIG. 1 is used. This embodiment inputs a captured image to the DL model and outputs an upscaled image, but may input the imaging condition and development condition to the DL model together with the captured image using the method described in step S102. In a case where the low-resolution patch is enlarged using interpolation to the same number of pixels as that of the high-resolution patch and then input to the DL model for learning in step S102, the captured image is similarly enlarged using interpolation and then input to the DL model. The weight information on the DL model is transmitted from the learning apparatus 101 and stored in the memory 103a.

Next, in step S203, the blurred image processing unit 103d generates an upscaled image with a high effect (first image) by inputting the low-resolution patch to the DL model (second machine learning model) to generate an upscaled image with a lower effect (second image). A convolutional neural network similar to the configuration illustrated in FIG. 1 is used to generate the upscaled image with a low effect. Weight information for the DL model is transmitted from the learning apparatus 101 and stored in the memory 103a.

In this embodiment, an upscaled image with a high effect means an image with a high resolution, that is, an image with many high-frequency components. That is, in this embodiment, the second image has high-frequency components fewer than those of the first image. An image with many high-frequency components may be an image that contains many frequency components higher than those of the captured image (input image).

In this embodiment, a high frequency component of an image is expressed by the sum of absolute values of LH, HL, and HH corresponding to the high frequency component among four coefficients LL, LH, HL, and HH obtained by performing a one-level discrete wavelet transform to an image. The discrete wavelet transform is a frequency analysis method that decomposes the original signal into a high frequency component and a low frequency component using a wavelet function as a basis function. By performing a one-level discrete wavelet transform to an image as a two-dimensional signal, a high frequency component is obtained for each of the vertical (LH), horizontal (HL), and diagonal (HH) directions. This embodiment uses the Haar wavelet as the wavelet function. In addition, this embodiment uses a lifting scheme as a method for scaling (enlarging and reducing) the wavelet function. The lifting scheme is to divide a signal into even-numbered elements and odd-numbered elements, predict the odd-numbered elements using the even-numbered elements, and defines a shift from the prediction as a high frequency component and a residual as a low frequency component. In this case, a discrete wavelet coefficient of a one-dimensional signal x is expressed by the following equation (2):

$$d = x [ 0 \text{::} 2 ] - x [ 1 \text{::} 2 ] c = ( x [ 0 \text{::} 2 ] + x [ 1 \text{::} 2 ] ) / 2 \qquad ( 2 )$$

where d is a high frequency component of the one-dimensional signal x, c is a low frequency component of the one-dimensional signal x, x[0::2] represents an odd-numbered element of the one-dimensional signal x, and x[1::2] represents an even-numbered element of the one-dimensional signal x.

The captured image (input image) may be enlarged by bicubic interpolation to the same number of pixels as that of the upscaled image, and then the high frequency component is calculated and compared with the upscaled image.

In this embodiment, the high frequency component of the second upscaled image is less than ¼ of the high frequency component of the first upscaled image. The high frequency component of the second upscaled image may be less than ⅓ of the high frequency component of the first upscaled image. The high frequency component of the second upscaled image may be less than ½ of the high frequency component of the first upscaled image.

Next, in step S204, the image combining unit 103e generates a final upscaled image (third image) by calculating a weighted average of the upscaled image with a high effect and the upscaled image with a lower effect. This embodiment uses a predefined weight for the weighted average, but may use a weight for the weighted average specified by the user via the input apparatus 106.

In inputting a captured image to the DL model, it is not necessary to cut out the image to the same size as that of the low-resolution training patch that has been used during learning, but the image may be decomposed into a plurality of overlapping patches and then processed. In this case, the patches obtained after processing may be combined to form an upscaled image.

In this embodiment, the learning apparatus 101 and the image estimating unit 103 are separate, but this embodiment is not limited to this example. The learning apparatus 101 and the image estimating unit 103 may be integrated. In other words, learning (the processing illustrated in FIG. 4) and estimation (the processing illustrated in FIG. 5) may be performed within an integrated apparatus.

This embodiment can provide an image processing method and an image processing apparatus, each of which uses a DL model to generate two upscaled images with different effects with a small computational load.

### Second Embodiment

A description will now be given of an image processing system 300 according to a second embodiment of the present disclosure. In this embodiment, similarly to the first embodiment, learning of the DL model and image processing are executed. This embodiment is different from the first embodiment in that the image pickup apparatus acquires a captured image (low-resolution image) and processes the image.

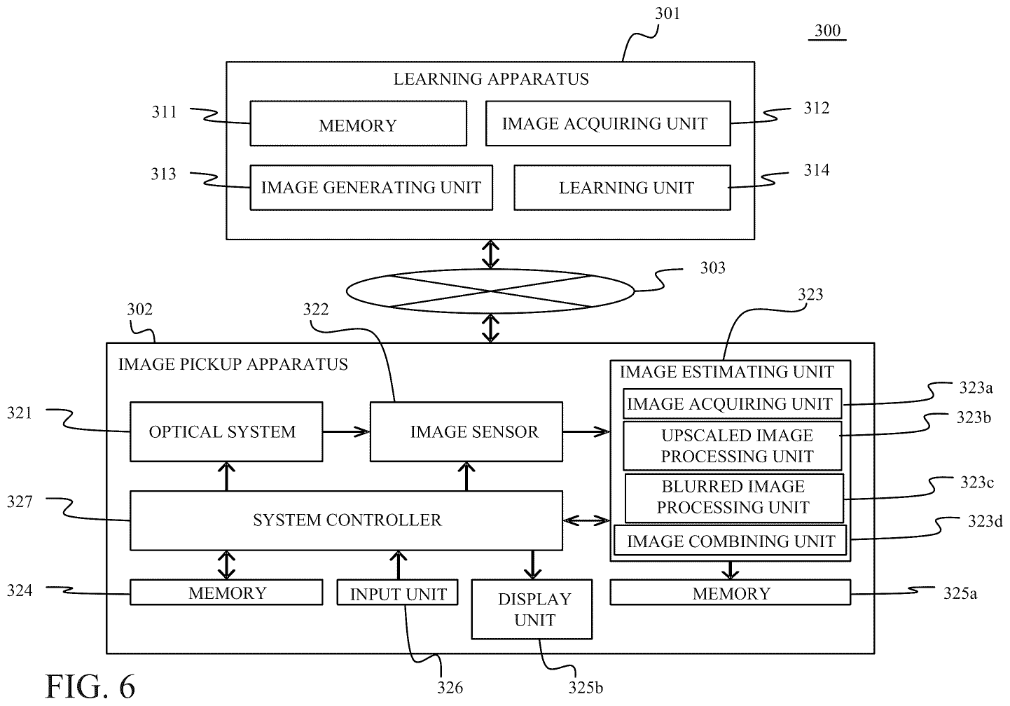

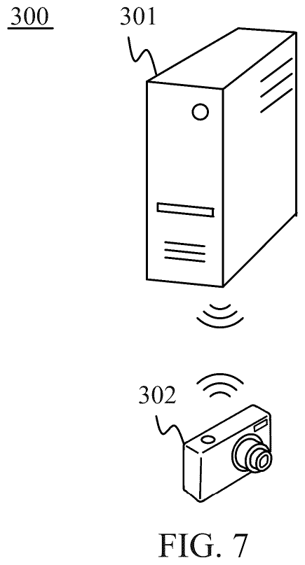

FIG. 6 is a block diagram of the image processing system 300. FIG. 7 is an external view of the image processing system 300. The image processing system 300 includes a learning apparatus 301, and an image pickup apparatus 302 that are connected via a network 303. The learning apparatus 301 and the image pickup apparatus 302 do not need to be constantly connected via the network 303.

The learning apparatus 301 includes a memory 311, an image acquiring unit 312, an image generator 313, and a learning unit 314. The learning apparatus 301 uses these units to learn the weight for the DL model.

The image pickup apparatus 302 captures the object space, acquires a captured image (low-resolution image), and generates an upscaled image of the captured image. Details of the image processing executed by the image pickup apparatus 302 will be described later. The image pickup apparatus 302 includes an optical system 321 and an image sensor 322. An image estimating unit 323 includes an image acquiring unit 323a, an upscaled image processing unit (first generator) 323b, a blurred image processing unit (second generator) 323c, and an image combining unit (third generator) 323d. Similarly to the first embodiment, the upscaled image processing unit 323b, the blurred image processing unit 323c, and the image combining unit 323d may be configured as an integrated DL model. Alternatively, the upscaled image processing unit 323b and the blurred image processing unit 323c may be configured as an integrated DL model, and the image combining unit 323d may be configured as a separate image processing unit. Alternatively, the upscaled image processing unit 323b and the blurred image processing unit 323c may be configured as separate DL models, and the image combining unit 323d may also be configured as a separate image processing unit.

In this embodiment, the learning of the DL model performed by the learning apparatus 301 is similar to the flowchart regarding the learning of the DL model described in the first embodiment with reference to FIG. 4, and thus a description thereof will be omitted.

Details of the image processing performed by the image pickup apparatus 302 will be described. Weight information on the DL model has been previously learned by the learning apparatus 301 and stored in the memory 311. The image pickup apparatus 302 reads out the weight information from the memory 311 via the network 303 and stores it in a memory 324. The image estimating unit 323 generates an upscaled image of the captured image using the weight information on the DL model stored in the memory 324, the captured image acquired from the image acquiring unit 323a, the upscaled image processing unit 323b, the blurred image processing unit 323c, and the image combining unit 323d. The generated upscaled image is stored in a memory 325a. In a case where an instruction to display the upscaled image is issued from the user via an input unit 326, the stored image is read out and displayed on a display unit 325b. The captured image and its image information stored in the memory 325a may be read out and upscaled by the image estimating unit 323. The above series of controls are performed by a system controller 327.

A description will now be given of the upscaled image processing using the DL model executed by the image estimating unit 323 according to this embodiment. The procedure of this image processing is substantially the same as the flowchart explained in the first embodiment with reference to FIG. 5, and thus a description will be given with reference to FIG. 5. Each step of the image processing is mainly executed by the image acquiring unit 323a, the upscaled image processing unit 323b, the blurred image processing unit 323c, or the image combining unit 323d in the image estimating unit 323.

First, in step S201, the image acquiring unit 323a acquires a captured image (low-resolution image, input image). In this embodiment, the captured image is acquired by the image pickup apparatus 302 and stored in the memory 324, but is not limited to this example.

Next, in step S202, the upscaled image processing unit 323b generates an upscaled image with a high effect (first image) by inputting the captured image to the DL model (first machine learning model). A convolutional neural network similar to the configuration illustrated in FIG. 1 is used to generate an upscaled image with a high effect. This embodiment inputs a captured image to the DL model and outputs an upscaled image, but may input the imaging condition and development condition to the DL model together with the captured image using the method described in step S102. The weight information on the DL model is one that has been transmitted from the learning apparatus 301 and stored in the memory 324.

Next, in step S203, the blurred image processing unit 323c inputs the upscaled image with a high effect (first image) to the DL model (second machine learning model) and thereby generates an upscaled image with a lower effect (second image) in comparison with the upscaled image with the high effect. A convolutional neural network similar to the configuration illustrated in FIG. 1 is used to generate the upscaled image with a low effect. The weight information on the DL model has been transmitted from the learning apparatus 301 and stored in the memory 324.

Next, in step S204, the image combining unit 323d generates a final upscaled image (third image) by calculating a weighted average of the upscaled image with a high effect and the upscaled image with a lower effect. This embodiment uses a predefined weight for the weighted average, but may use a weight for the weighted average specified by the user via the input unit 326.

In inputting a captured image to the DL model, it is not necessary to cut out the captured image to the same size as that of the low-resolution training patch that was used during learning, but the captured image may be decomposed into a plurality of overlapping patches and then processed. In that case, the patches obtained after processing may be combined to form an upscaled image.

This embodiment can provide an image pickup apparatus that generates two upscaled images with different effects using a DL model with a small calculation load.

### Third Embodiment

A description will now be given of an image processing system 400 according to a third embodiment of the present disclosure. This embodiment is different from the first and second embodiments in that it has a processing apparatus (computer) that transmits a captured image (low-resolution image) that is a target of image processing to an image estimating unit (image processing apparatus) and receives a processed output image (upscaled image) from the image estimating apparatus.

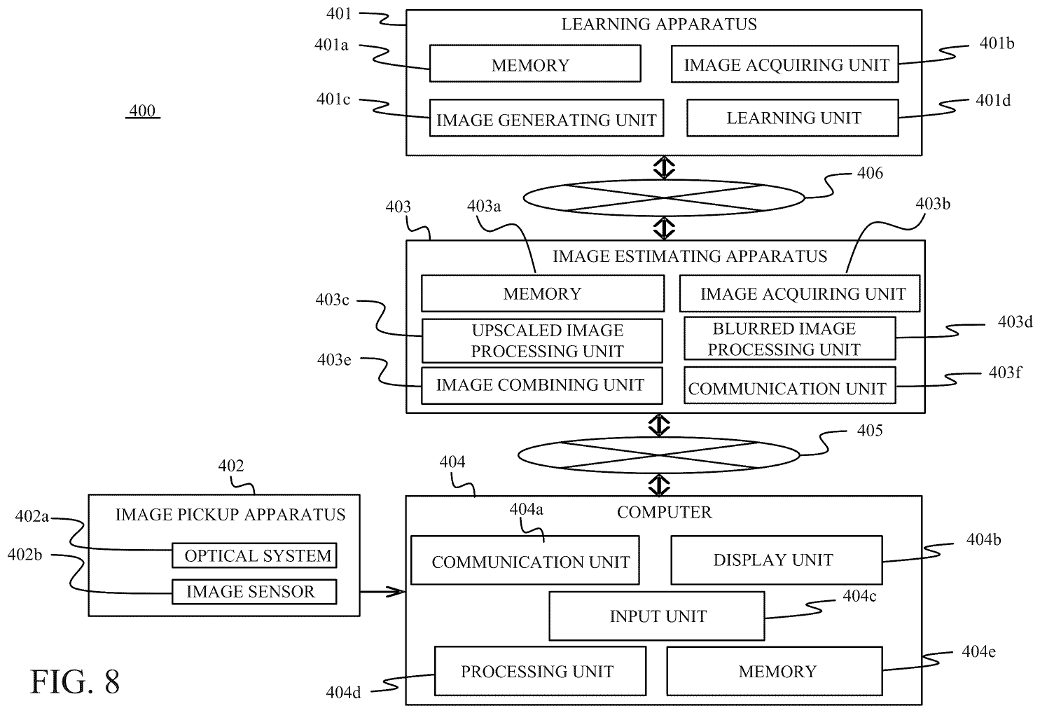

FIG. 8 is a block diagram of the image processing system 400. The image processing system 400 includes a learning apparatus 401, an image pickup apparatus 402, an image estimating apparatus (image processing apparatus) 403, and a computer (control apparatus) 404. The learning apparatus 401 and the image estimating apparatus 403 are, for example, servers. The computer 404 is, for example, a user terminal (a personal computer, a smartphone, or a camera). The computer 404 is connected to the image estimating apparatus 403 via a network 405. The image estimating apparatus 403 is connected to the learning apparatus 401 via a network 406.

That is, the computer 404 and the image estimating apparatus 403 can communicate with each other, and the image estimating apparatus 403 and the learning apparatus 401 can communicate with each other. The learning apparatus 401 corresponds to a third device, the computer 404 corresponds to a fourth device, and the image estimating apparatus 403 corresponds to a fifth apparatus.

The configuration of the learning apparatus 401 is similar to that of the learning apparatus 101 of the first embodiment, and thus a description thereof will be omitted. The configuration of the image pickup apparatus 402 is similar to that of the image pickup apparatus 102 of the first embodiment, and thus a description thereof will be omitted.

The image estimating apparatus 403 includes a memory 403a, an image acquiring unit 403b, an upscaled image processing unit (first generator) 403c, a blurred image processing unit (second generator) 403d, an image combining unit (third generator) 403e, and a communication unit (receiver) 403f. The memory 403a, the image acquiring unit 403b, the upscaled image processing unit 403c, the blurred image processing unit 403d, and the image combining unit 403e are similar to the memory 103a, the image acquiring unit 103b, the upscaled image processing unit 103c, the blurred image processing unit 103d, and the image combining unit 103e. As in the first embodiment, the upscaled image processing unit 403c, the blurred image processing unit 403d, and the image combining unit 403e may be configured as an integrated DL model. Alternatively, the upscaled image processing unit 403c and the blurred image processing unit 403d may be configured as an integrated DL model, and the image combining unit 403e may be configured as a separate image processing unit. Alternatively, the upscaled image processing unit 403c and the blurred image processing unit 403d may be configured as separate DL models, and the image combining unit 403e may also be configured as a separate image processing unit. The communication apparatus 403f has a function of receiving a request transmitted from the computer 404, and a function of transmitting an output image (third image) generated by the image estimating apparatus 403 to the computer 404.

The computer 404 includes a communication unit (transmitter) 404a, a display unit 404b, an input unit 404c, a processing unit 404d, and a memory 404e. The communication unit 404a has a function of transmitting a request (request for execution of processing on the input image) to the image estimating apparatus 403 to cause the image estimating apparatus 403 to execute processing on the captured image (input image, low-resolution image). The communication unit 404a also has a function of receiving an output image (third image) processed by the image estimating apparatus 403.

The display unit 404b has a function of displaying various information. The information displayed by the display unit 404b includes, for example, a captured image (low-resolution image) to be transmitted to the image estimating apparatus 403 and an output image (third image) received from the image estimating apparatus 403. The input unit 404c receives an instruction from a user to start image processing, etc. The processing unit 404d has a function of performing image processing including noise reduction and sharpness on the output image (third image) received from the image estimating apparatus 403. The memory 404e stores the captured image acquired from the image pickup apparatus 402, the output image received from the image estimating apparatus 403, etc.

The learning of the DL model executed by the learning apparatus 401 is similar to the flowchart regarding the learning of the DL model illustrated in FIG. 4 of the first embodiment, and thus a description thereof will be omitted.

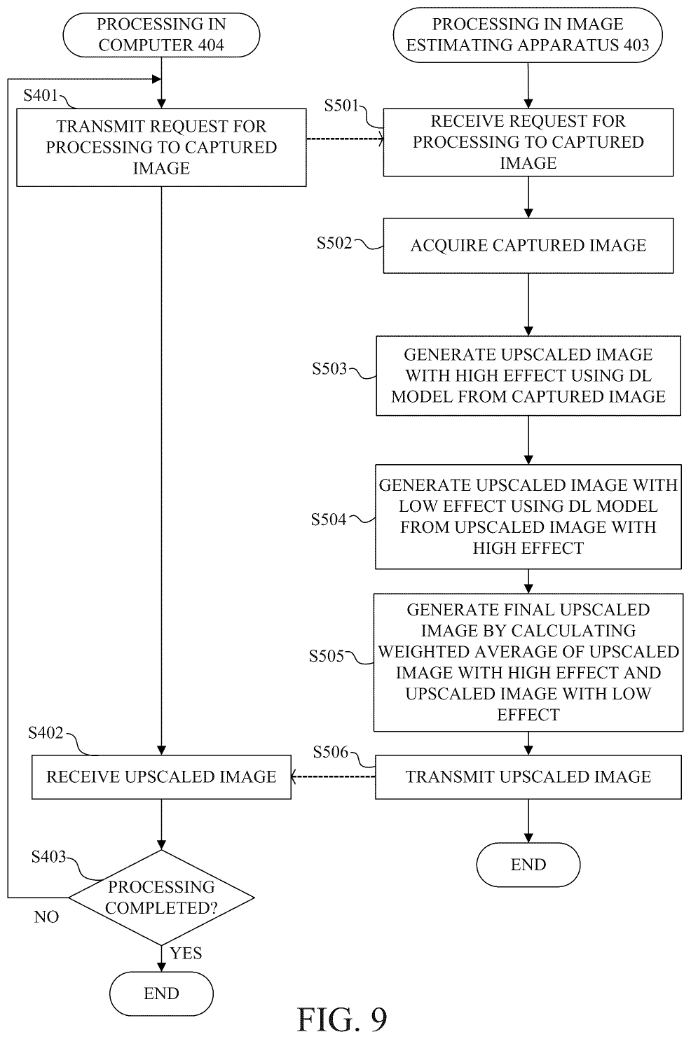

Referring now to FIG. 9, a description will be given of the image processing in this embodiment. FIG. 9 is a flowchart regarding generation of an output image using the DL model (first machine learning model, second machine learning model) in this embodiment. The image processing illustrated in FIG. 9 is started in a case where a user issues an instruction to start image processing via the computer 404.

A description will now be given of the operation of the computer 404. In step S401, the computer 404 transmits a request for processing a captured image (low-resolution image) to the image estimating apparatus 403. The captured image to be processed and its image information may be transmitted to the image estimating apparatus 403 by any method. For example, the captured image and its image information may be uploaded to the image estimating apparatus 403 simultaneously with step S401, or may be uploaded to the image estimating apparatus 403 before step S401. The captured image may be an image stored on a server different from the image estimating apparatus 403. In step S401, the computer 404 may transmit an ID for authenticating the user together with the request for processing the captured image.

Next, in step S402, the computer 404 receives an output image (upscaled image, third image) generated in the image estimating apparatus 403.

A description will now be given of the operation of the image estimating apparatus 403. First, in step S501, the image estimating apparatus 403 receives a request for processing the captured image (input image, low-resolution image) transmitted from the computer 404. The image estimating apparatus 403 determines that processing for the captured image has been instructed, and executes the processing in and after step S502.

Next, in step S502, the image acquiring unit 403b acquires the captured image. In this embodiment, the captured image is transmitted from the computer 404. The imaging condition and development condition may also be acquired together with the captured image, and used in the steps described below.

Next, in step S503, the upscaled image processing unit 403c generates an upscaled image with a high effect (first image) by inputting the captured image to a DL model (first machine learning model). This embodiment inputs the captured image to the DL model and outputs an upscaled image with a high effect, but may input the imaging condition and development condition to the DL model along with the captured image using the method described in step S102.

Next, in step S504, the blurred image processing unit 403d inputs the upscaled image with a high effect (first image) to the DL model (second machine learning model) and thereby generates an upscaled image with a low effect (second image) in comparison with the upscaled image with a high effect.

Next, in step S505, the image combining unit 403e generates a final upscaled image (third image) by calculating a weighted average of the upscaled image with a high effect and the upscaled image with a lower effect. This embodiment uses a predefined weight for the weighted average, but may use a weight for the weighted average specified by the user via the input unit 404c.

Next, in step S506, the image estimating apparatus 403 transmits an output image (upscaled image, third image) to the computer 404.

This embodiment can provide an image processing system that generates two upscaled images with different effects using a DL model with a small computational load.

Each embodiment generates the first image by inputting an input image (captured image) into the first machine learning model, but is not limited to this example. For example, an image (image based on the input image) obtained by enlarging the input image to the same number of pixels as that of the first image using interpolation may be input into the first machine learning model. Similarly, instead of learning of the first machine learning model based on the first training image, the first machine learning model may be learned based on an image (image based on the first training image) obtained by enlarging the first training image using interpolation.

### Other Embodiments

Embodiment(s) of the disclosure can also be realized by a computer of a system or apparatus that reads out and executes computer-executable instructions (e.g., one or more programs) recorded on a memory (which may also be referred to more fully as a ‘non-transitory computer-readable memory’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the memory to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the memory. The memory may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can provide an image processing method that can generate upscaled images with a small computational load.

This application claims priority to Japanese Patent Applications Nos. 2023-190848, which was filed on Nov. 8, 2023, and 2024-176390, which was filed on Oct. 8, 2024, and each of which is hereby incorporated by reference herein in its entirety.

What is claimed is:

1. An image processing method comprising:
generating a first image by inputting an input image or an image based on the input image into a first machine learning model;
generating a second image by inputting the generated first image into a second machine learning model different from the first machine learning model; and
generating a third image using the first image and the second image,
wherein each of the first image, the second image, and the third image has a larger number of pixels than those of the input image, and
wherein the second image has fewer high-frequency components than those of the first image.

2. The image processing method according to claim 1, wherein a scale of the second machine learning model is smaller than that of an output layer of the first machine learning model.

3. The Image processing method according to claim 2, wherein a scale of the second machine learning model is smaller than half of an overall scale of the first machine learning model.

4. The image processing method according to claim 2, wherein the output layer of the first machine learning model includes a single convolution layer, and
wherein the scale of each of the output layer of the first machine learning model and the second machine learning model is expressed by the following equation:
$${\sum }_{l = 1}^{L} {k}_{l} \times {k}_{l} \times {c}_{l} \times {n}_{l}$$
where L is the number of convolution layers, k₁ is a kernel size of a convolution filter in an 1-th layer (1=1 to L), c₁ is the number of channels in the convolution filter in the 1-th layer, and n₁ is the number of convolution filters in the 1-th layer.

5. The image processing method according to claim 1, wherein the high-frequency components are frequency components higher than frequency components of the input image.

6. The image processing method according to claim 1, wherein the number of pixels of the first image, the number of pixels of the second image, and the number of pixels of the third image are equal to one another.

7. The image processing method according to claim 1, wherein the third image is generated by calculating a weighted average of the first image and the second image by using a first weight of the first image and a second weight of the second image.

8. An image processing apparatus comprising:
a processor configured to:
generate a first image by inputting an input image or an image based on the input image into a first machine learning model;
generate a second image by inputting the first image into a second machine learning model different from the first machine learning model; and
generate a third image by using the first image and the second image,
wherein each of the first image, the second image, and the third image has a larger number of pixels than those of the input image, and
wherein the second image has fewer high-frequency components than those of the first image.

9. An image pickup apparatus comprising:
an image processing apparatus according to claim 8; and
an image sensor.

10. A non-transitory computer-readable memory storing a program that causes a computer to execute the image processing method according to claim 1.

11. A method of training a machine learning model comprising:
acquiring a first training image having a low resolution or an image based on the first training image, and a second training image having a high resolution corresponding to the first training image; and
training a first machine learning model and a second machine learning model based on the first training image or the image based on the first training image and the second training image,
wherein a calculating method of a loss during training of the first machine learning model and a training method of a loss during learning of the second machine learning model are different from each other.

12. The learning method according to claim 11, wherein the loss during the training of the first machine learning model is calculated using an adversarial loss based on a first upscaled patch generated by inputting the first training image to the first machine learning model, and the second training image, and
wherein the loss during the training of the second machine learning model is calculated using a mean squared error based on a second upscaled patch generated by inputting the first upscaled patch to the second machine learning model.

13. The learning method according to claim 11, wherein the first machine learning model and the second machine learning model are simultaneously trained.

14. A learning apparatus comprising:
a processor configured to:
acquire a first training image having a low resolution or an image based on the first training image, and a second training image having a high resolution corresponding to the first training image; and
train a first machine learning model and a second machine learning model based on the first training image or the image based on the first training image and the second training image,
wherein a calculating method of a loss during learning of the first machine learning model and a calculating method of a loss during learning of the second machine learning model are different from each other.

15. A non-transitory computer-readable memory storing a program that causes a computer to execute the learning method according to claim 11.

16. An image processing system comprising:
an image processing apparatus according to claim 8; and
a control apparatus communicable with the image processing apparatus,
wherein the control apparatus includes a transmitter configured to transmit a request regarding execution of processing to an input image or an image based on the input image, to the image processing apparatus, and
wherein the image processing apparatus generates the third image by executing the processing to the input image according to the request.
